(19) United States
(12) Patent Application Publication
(10) Pub. No.: US 2012/0198082 A1
(43) Pub. Date: Aug. 2, 2012

(54) Automatic Fallback Communication Mechanism

(76) Inventors: Joseph Gaertner, Lafayette, CO (US); Silviu Nanau, Giroc (RO); Eugen Circa, Gataia (RO)

(21) Appl. No.: 13/014,871

(22) Filed: Jan. 27, 2011

(51) Int. Cl. G06F 15/16

(52) U.S. Cl. 709/228

(57) ABSTRACT

A method disclosed. The method includes attempting to communicate with a printer in a network via a first network communications protocol, determining if the communication with the printer is successful via the first network communications protocol and automatically communicating with the printer via a second network communications protocol if communication via the first network communications protocol the printer is unsuccessful.

### FIELD OF THE INVENTION

The invention relates to the field of printing systems, and in particular, to network management for printing systems.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Currently, printers are included in networking infrastructures that are managed remotely from one or more interconnecting devices (e.g., a server), often at a central location. It is not unusual for large organization to manage in excess of one thousand printers in a networking infrastructure. In many instances, these networking infrastructures are managed using a Simple Network Management Protocol (SNMP) network management protocol.

The SNMP network management protocol has evolved from its original configuration. In particular, SNMP now has several versions available (e.g., v1, v2, and v3), with more versions expected to follow. Each version may include differences in operation, as well as in a set of parameters that may be selected by an administrator. For example, SNMP v1 and v2 protocols employ community strings for authentication, whereas, SNMP v3 employs a user identifier (e.g., user_id) for authentication and further enables the administrator to specify encryption of data.

Current networking infrastructures implement SNMP v3 to configure a print server to communicate with printers in the network. Typically such configurations are performed in mass, with most of the printers in the network being configured at the same time. However with a large magnitude of printers in a networking infrastructure, many of the printers may not support SNMP v3. Thus, a network administrator would find it necessary to ascertain which printers do support SNMP v3 in order to properly configure the print server to operate properly with each printer in the network. Those printers that do not support SNMP v3 would subsequently have to be configured separately via a less complex protocol (e.g., SNMP v1 or v2).

Accordingly, a mechanism to automatically configure a print server using a fallback network management protocol is desired.

### SUMMARY

In one embodiment a method is disclosed. The method includes attempting to communicate with a printer in a network via a first network communications protocol, determining if the communication with the printer is successful via the first network communications protocol and automatically communicating with the printer via a second network communications protocol if communication via the first network communications protocol the printer is unsuccessful.

In another embodiment, a printer server is disclosed. The server includes a communication module configured to communicate with one or more printers in a network via a first network communications protocol and to automatically communicate with a first of the one or more printers via a second network communications protocol upon detecting a failure to communicate with the first printer via the first network communications protocol.

In yet another embodiment, a network is disclosed. The network includes a first printer configured to communicate via a Simple Network Management Protocol (SNMP) version 3 protocol and a SNMP version 1 protocol, a second printer configured to communicate via the SNMP version 1 protocol and a printer server. The server includes a communication module configured to establish communication via the SNMP version 3 protocol and to automatically establish communication via the SNMP version 1 protocol upon detecting a failure to communicate via the SNMP version 3 protocol.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of a server communicatively coupled to printers in a network;

FIG. 3 is a flow diagram illustrating one embodiment for a print server configuration process; and

FIG. 4 illustrates one embodiment of a computer system.

### DETAILED DESCRIPTION

An automatic fallback printer configuration mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

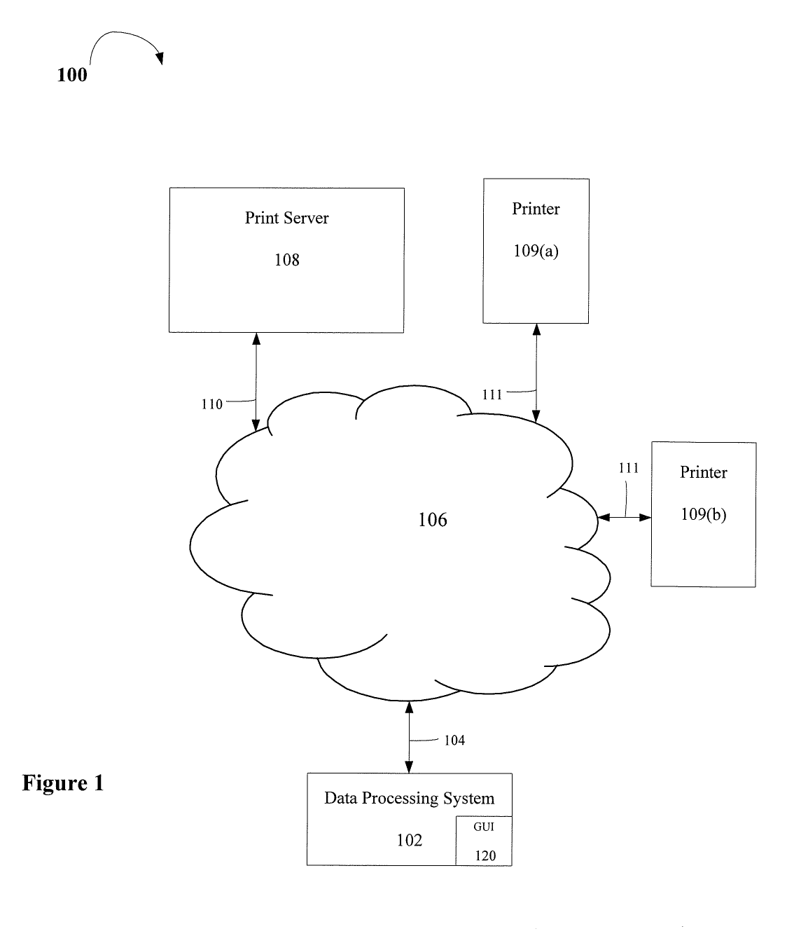

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

Although described as separate entities, other embodiments may include print server 108 being incorporated in one or more of the printers 109. However in other embodiments, the print server and printer may be physically separate entities. Therefore, the data processing system network 100 depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 and one or more of printers 109. In other embodiments, the printing software product manages printing of documents from multiple data processing systems 102 to the one or more printers 109.

In a further embodiment, the printing software product may be implemented using either InfoPrint Manager (IPM) or InfoPrint ProcessDirector (IPPD), although other types of printing software may be used instead. In yet a further embodiment, the print application at data processing system 102 interacts with the printing software product to provide for efficient transmission of print jobs.

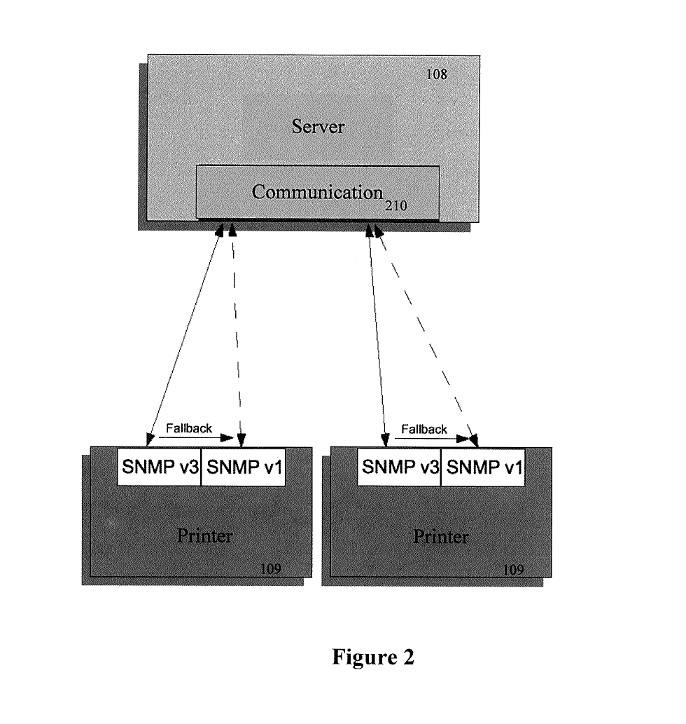

In one embodiment, the printing software product communicates with printers 109 via a SNMP network management protocol. FIG. 2 illustrates an embodiment of server 108 communicatively coupled to printers 109. As shown in FIG. 2, server 108 includes a communication module 210 that enables the printing software product to configure printers 109. According to one embodiment, printers 109 are enabled to communicate using both SNMPv1 and SNMPv3. As discussed above, the SNMPv3 protocol offers user authentication and data encryption across network, while the SNMPv1 protocol provides less security.

In a further embodiment, communication module 210 attempts to communicate with printers 109, on the more secure protocol (e.g., SNMP v3). However, if the communication fails, communication module 210 will automatically attempt communication on the less secure protocol (e.g., SNMP v1). The SNMP v3 communication may fail, for example, if a printer 109 does not support the protocol. Further, the SNMP v3 communication may fail because a user of the printing software product may set the SNMP v3 with an incorrect authentication credential.

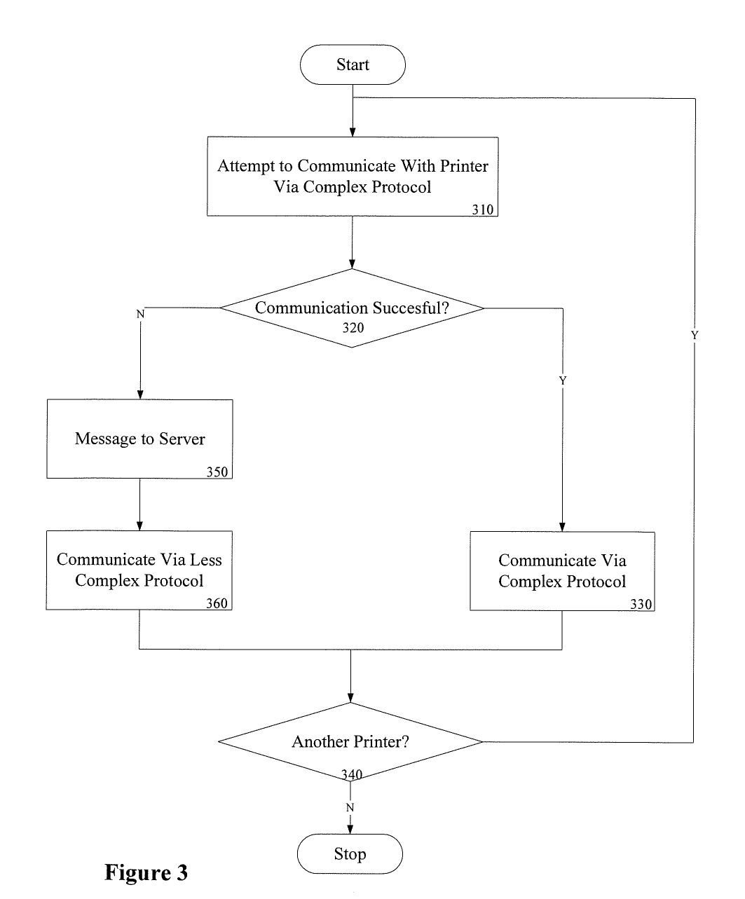

FIG. 3 is a flow diagram illustrating one embodiment of a process for a printing software product at server 108 establishing communication via communication module 210 to communicate with printers 109. At processing block 310, communication module 210 attempts to communicate with a printer via a complex protocol (e.g., SNMP v3). At decision block 320, it is determined whether the communication is successful.

If the communication is successful, the printing software product communicates with the printer using the complex protocol, processing block 330. At processing block 340, it is determined whether there is another printer in the network in which server 108 is to communicate. If so, control is returned to processing block 310 where communication module 210 attempts to communicate with the next printer via the complex protocol. Otherwise, the communication process has been completed.

If at decision block 320 it is determined that the communication with the initial printer has failed, a message is forwarded to communication module 210 indicating the failed connection. In one embodiment, the message may indicate the reason for the failed connection (e.g., printer does not support the protocol or incorrect authentication credential received), processing block 350. At processing block 360, communication module 210 automatically switches the print server to communicate via a less complex protocol (e.g., SNMP v1). Control is then forwarded to processing block 340 where it is determined whether there is another printer in the network for which the print server is to communicate.

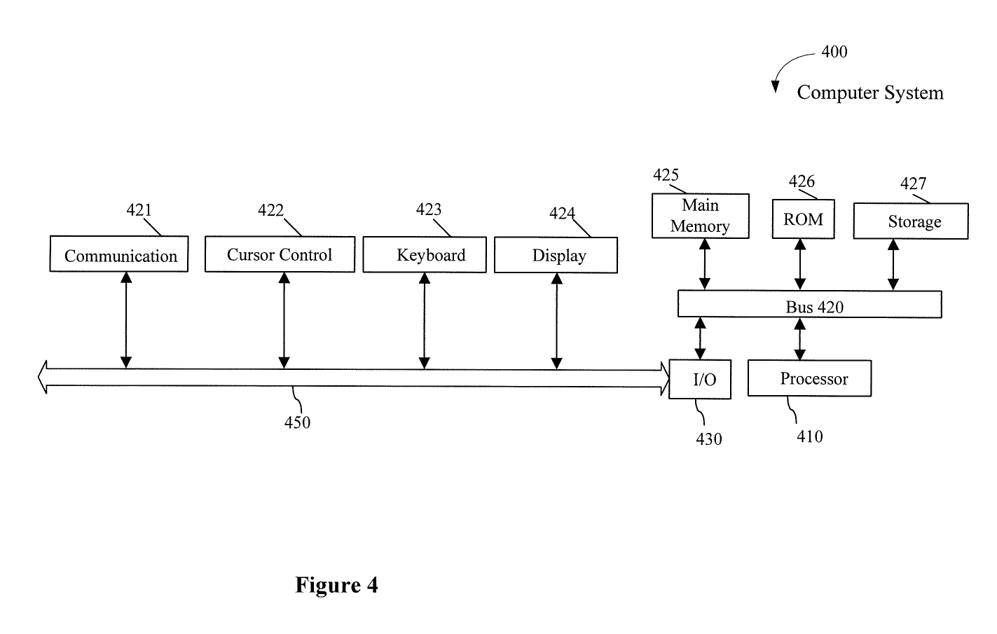

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 325 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

The above described mechanism prevent communication failures between a server and network printers by automatically establishing communication using a less complex protocol upon detecting a communication failure between the server and a printer using a complex protocol.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A printer server comprising a communication module configured to communicate with one or more printers in a network via a first network communications protocol and to automatically communicate with a first of the one or more printers via a second network communications protocol upon detecting a failure to communicate with the first printer via the first network communications protocol.

2. The printer server of claim 1 wherein the communication module attempts to communicate with a second of the one or more printers via the first network communications protocol upon communicating with the first printer via the second communications protocol.

3. The printer server of claim 2 wherein the communication module communicates with the second printer upon establishing communications with the second printer via the first network communications protocol.

4. The printer server of claim 3 wherein the communication module automatically communicates with the second printer via the second network communications protocol upon detecting a failure to communicate with the first network communications protocol.

5. The printer server of claim 1 wherein the failure to communicate with the first printer via the first network communications protocol is attributed to the first printer not having a capability of communicating via for the first network communications protocol.

6. The printer server of claim 1 wherein the failure to communicate with the first printer via the first network communications protocol is attributed to an incorrect authorization credential being transmitted from the communication module to the first printer.

7. The printer server of claim 1 wherein the first network communications protocol is a complex protocol and the second network communications protocol is less complex than the first network communications protocol.

8. The printer server of claim 1 wherein the first network communications protocol is a Simple Network Management Protocol (SNMP) version 3 network management protocol and the second network communications protocol is a SNMP version 1 network management protocol.

9. A method comprising:
attempting to communicate with a printer in a network via a first network communications protocol;
determining if the communication with the printer is successful via the first network communications protocol; and
automatically communicating with the printer via a second network communications protocol if communication via the first network communications protocol the printer is unsuccessful.

10. The method of claim 9 further comprising receiving a message from the printer indicating that communication failed via the first network communications protocol the printer was unsuccessful.

11. The method of claim 10 wherein the unsuccessful communication via the first network communications protocol is attributed to the first printer not having a capability of communicating via for the first network communications protocol.

12. The method of claim 11 wherein the unsuccessful communication via the first network communications protocol is attributed to an incorrect authorization credential being transmitted from the communication module to the first printer.

13. The method of claim 11 further comprising:
attempting to communicate with a second printer via the first network communications protocol after communicating with the first printer;
determining if the communication with the second printer is successful via the first network communications protocol; and
automatically communicating with the second printer via the second network communications protocol if communication via the first network communications protocol the printer is unsuccessful.

14. The method of claim 9 wherein the first network communications protocol is a Simple Network Management Protocol (SNMP) version 3 network management protocol and the second network communications protocol is a SNMP version 1 network management protocol.

15. A network comprising:
a first printer configured to communicate via a Simple Network Management Protocol (SNMP) version 3 protocol and a SNMP version 1 protocol;
a second printer configured to communicate via the SNMP version 1 protocol; and
a printer server comprising a communication module configured to establish communication via the SNMP version 3 protocol and to automatically establish communication via the SNMP version 1 protocol upon detecting a failure to communicate via the SNMP version 3 protocol.

16. The printing network of claim 15 wherein the failure to communicate with the first printer via the SNMP version 3 protocol is attributed to an incorrect authorization credential being transmitted from the communication module to the first printer.

17. The printing network of claim 15 wherein the failure to communicate with the second printer via the SNMP version 3 protocol is attributed the second printer not having a capability of communicating via SNMP version 3.

18. The printing network of claim 15 wherein the printer server attempts to communicate with the second printer via the SNMP version 3 protocol upon communicating with the first printer via the SNMP version 1 protocol.

19. The printing network of claim 18 wherein the printer server communicates with the second printer upon establishing communications with the second printer via the SNMP version 3 protocol.

20. The printing network of claim 19 wherein the printer server automatically communicates with the second printer via the SNMP version 1 protocol upon detecting a failure to communicate with the SNMP version 3 protocol.
